(19) United States
(12) Patent Application Publication
(10) Pub. No.: US 2014/0211795 A1
(43) Pub. Date: Jul. 31, 2014

(54) COMMUNICATION SYSTEM, CONTROL DEVICE, NODE, NODE CONTROL METHOD, AND PROGRAM

(71) Applicants: Yasunobu Chiba, Tokyo (JP); Hideyuki Shimonishi, Tokyo (JP)

(72) Inventors: Yasunobu Chiba, Tokyo (JP); Hideyuki Shimonishi, Tokyo (JP)

(73) Assignee: NEC Corporation, Tokyo (JP)

(21) Appl. No.: 14/241,813

(22) PCT Filed: Aug. 27, 2012
(86) PCT No.: PCT/JP2012/005366

§ 371 Date: Feb. 27, 2014

(30) Foreign Application Priority Data
Aug. 29, 2011 (JP) 2011-186096

(51) Int. Cl. H04L 12/947

(52) U.S. Cl. CPC H04L 49/25
USPC 370/389

(57) ABSTRACT

A control device is connected to a node and to a packet processing unit. The node operates according to a processing rule that includes a matching rule, against which a received packet is matched, and processing content applied to a packet that matches the matching rule. The packet processing unit performs packet processing according to a predetermined specification. The control device inputs a packet, received from the node to request to create a processing rule, to the packet processing unit in response to a request from the node. The control device creates a processing rule corresponding to a packet processing result of the packet processing unit obtained as a result of the input and sets the created processing rule in the node.

### CROSS-REFERENCE TO RELATED APPLICATIONS

The present invention claims priority from Japanese Patent Application 2011-186096 (filed on Aug. 29, 2011) the content of which is hereby incorporated in its entirety by reference into this specification.

### TECHNICAL FIELD

The present invention relates to a communication system, a control device, a node, a node control method, and a program, and more particularly to a communication system in which a control device for centrally controlling the nodes is provided, the control device, a node, a node control method, and a program.

### BACKGROUND

Recently, the technology called OpenFlow is proposed (see Patent Literature 1 and Non Patent Literatures 1 and 2). OpenFlow identifies communications as end-to-end flows and performs path control, failure recovery, load balancing, and optimization on a per-flow basis. An OpenFlow switch, which is specified in Non Patent Literature 2, has a secure channel for communication with an OpenFlow controller, and operates according to the flow table to which information is added, and whose contents are rewritten, according to an instruction from the OpenFlow controller as necessary. In the flow table, a set of the following three is defined for each flow: a matching rule (Header Fields) against which a packet header is matched, flow statistical information (Counters), and an instruction (Instructions) that defines processing contents (see FIG. 17).

For example, when a packet is received, the OpenFlow switch searches the flow table for an entry that has a matching rule (see Header fields in FIG. 17) that matches the header information of the received packet. If an entry matching the received packet is found as a result of the search, the OpenFlow switch updates the flow statistical information (Counters) and, at the same time, performs the processing contents (packet transmission from a specified port, flooding, drop, etc.), described in the Instructions field of the entry, for the received packet. On the other hand, if an entry matching the received packet is not found as a result of the search, the OpenFlow switch transmits a request to set an entry via the secure channel, that is, a request to determine the processing content of the received packet, to the OpenFlow controller. The OpenFlow switch receives a flow entry, corresponding to the request, and updates the flow table. In this way, the OpenFlow switch forwards a packet using an entry, stored in the flow table, as the processing rule.

Non Patent Literature 3 proposes a technology, called RouteFlow, used to build a virtual network environment using OpenFlow described above.

### CITATION LIST

### Patent Literature

### [PTL 1]

International Publication No. WO2008/095010

### Non Patent Literature

### [NPL 1]

Nick McKeown and seven other authors, “OpenFlow: Enabling Innovation in Campus Networks”, [online], [Searched on May 26, 2011], Internet <URL: http://www.openflow.org/documents/openflow-wp-latest.pdf>

### [NPL 2]

“Openflow Switch Specification” Version 1.1.0. Implemented (Wire Protocol 0x02) [Searched on May 26, 2011], Internet <URL: http://www.openflow.org/documents/openflow-spec-v1.1.0.pdf>

### [NPL 3]

“Virtual Routers as a Service: The RouteFlow Approach Leveraging Software-Defined Network” [Searched on Jul. 11, 2011], Internet <URL:http://sites.google.com/site/routeflow/documents/routeflow-virtual-ip-sdn-CFI-2011.pdf?attredirects=0>

### SUMMARY

### Technical Problem

The following analysis is given by the present invention. In a network that uses OpenFlow described above, there is a demand for installing a communication device, such as a router or a gateway, as a virtual node at a boundary with an external network or within the network. In some cases, there is also a need to install a legacy communication device such as a layer-2 switch.

For example, to have a particular (OpenFlow) switch operate as a router, one method is to install a router packet processing mechanism in the (OpenFlow) controller for performing routing using a routing table that is dynamically updated by the Routing Information Protocol (RIP), Open Shortest Path First (OSPF), and Border Gateway Protocol (BGP), as shown in FIG. 18. In this case, a flow entry for implementing the operation equivalent to that of a router is created while updating the routing table in the (OpenFlow) controller. However, this method requires the router packet processing mechanism be installed in the controller, leading to an increase in the development costs.

Non Patent Literature 3 proposes the introduction of a RouteFlow server that manages a virtual network environment in which virtual IP routing engines are interconnected. However, the method disclosed in Non Patent Literature 3 requires a daemon, which is called RouteFlow slave and arranged in each virtual machine in the virtual network environment, to monitor a change in the routine table or the Address Resolution Protocol (ARP) table as shown in FIG. 19 for reflecting the change serially on the flow entries. This method also has the problem that the installation cost will increase.

An object of the present invention is to provide a configuration that allows an OpenFlow network node to perform the operation equivalent to that of a specification-conforming communication device at a low cost.

### Solution to Problem

According to a first aspect of the present invention, there is provided a communication system, comprising a node that operates according to a processing rule, the processing rule including a matching rule, against which a received packet is matched, and processing content applied to a packet that matches the matching rule; and a control device that sets the processing rule in the node in response to a request from the node. The control device is connected to a packet processing unit that performs packet processing according to a predetermined specification and the control device comprises a processing rule creation unit that inputs a packet, received from the node to request to create a processing rule, to the packet processing unit and creates a processing rule corresponding to a packet processing result of the packet processing unit obtained as a result of the input.

According to a second aspect of the present invention, there is provided a control device, which is connected to a node that operates according to a processing rule and to a packet processing unit that performs packet processing according to a predetermined specification, the processing rule including a matching rule, against which a received packet is matched, and processing content applied to a packet that matches the matching rule. The control device comprising a processing rule creation unit that inputs a packet, received from the node to request to create a processing rule, to the packet processing unit in response to a request from the node and creates a processing rule corresponding to a packet processing result of the packet processing unit obtained as a result of the input; and a processing rule setting unit that sets the created processing rule in the node.

According to a third aspect of the present invention, there is provided a node, which is connected to a packet processing unit that performs packet processing according to a predetermined specification. The node comprises a node-side packet processing unit that processes a packet according to a processing rule, the processing rule including a matching rule, against which a received packet is matched, and processing content applied to a packet that matches the matching rule; and a processing rule creation unit that inputs a packet, which does not match the matching rule, to the packet processing unit to create a processing rule corresponding to a packet processing result of the packet processing unit obtained as a result of the input.

According to a fourth aspect of the present invention, there is provided a node control method, comprising: using a control device connected to a node and to a packet processing unit, the node operating according to a processing rule that includes a matching rule, against which a received packet is matched, and processing content applied to a packet that matches the matching rule, the packet processing unit performing packet processing according to a predetermined specification. The control device performs processing comprising the steps of: inputting a packet, received from the node to request to create a processing rule, to the packet processing unit in response to a request from the node; creating a processing rule corresponding to a packet processing result of the packet processing unit obtained as a result of the input; and setting the created processing rule in the node. This method is associated with a particular machine called a control device that controls the node.

According to a fifth aspect of the present invention, there is provided a program that causes a computer, which configures a control device connected to a node and to a packet processing unit, the node operating according to a processing rule that includes a matching rule, against which a received packet is matched, and processing content applied to a packet that matches the matching rule, the packet processing unit performing packet processing according to a predetermined specification. The program causes the computer to perform the processing of inputting a packet, received from the node to request to create a processing rule, to the packet processing unit in response to a request from the node; creating a processing rule corresponding to a packet processing result of the packet processing unit obtained as a result of the input; and setting the created processing rule in the node. This program may be recorded on a computer readable storage medium, which is non-transitory. That is, the present invention may be implemented as a computer program product.

### Advantageous Effects of Invention

The present invention allows a node in an OpenFlow network to behave as a communication device without additional cost.

### BRIEF DESCRIPTION OF DRAWINGS

FIG. 1 is a diagram showing the outline of one exemplary embodiment of the present invention.

FIG. 2 is a sequence diagram showing the operation outline of one exemplary embodiment of the present invention.

FIG. 3 is a block diagram showing the configuration of a first exemplary embodiment of the present invention.

FIG. 4 is a diagram showing an example of information stored in the interface DB of a controller in the first exemplary embodiment of the present invention.

FIG. 5 is a flowchart showing the operation of the controller in the first exemplary embodiment of the present invention.

FIG. 6 is a diagram showing the operation of the first exemplary embodiment of the present invention.

FIG. 7 is a continuation of FIG. 6.

FIG. 8 is a continuation of FIG. 7.

FIG. 9 is a block diagram showing the outline configuration of a second exemplary embodiment of the present invention.

FIG. 10 is a block diagram showing the configuration of the second exemplary embodiment of the present invention.

FIG. 11 is a flowchart showing the operation of a controller in the second exemplary embodiment of the present invention.

FIG. 12 is a block diagram showing the outline configuration of a third exemplary embodiment of the present invention.

FIG. 13 is a block diagram showing the configuration of the third exemplary embodiment of the present invention.

FIG. 14 is a diagram showing an example of information stored in the interface DB of a controller in the third exemplary embodiment of the present invention.

FIG. 15 is a diagram showing an example of information stored in the input packet DB of the controller in the third exemplary embodiment of the present invention.

FIG. 16 is a flowchart showing the operation of the controller in the third exemplary embodiment of the present invention.

FIG. 17 is a diagram showing the configuration of a flow entry described in Non Patent Literature 2.

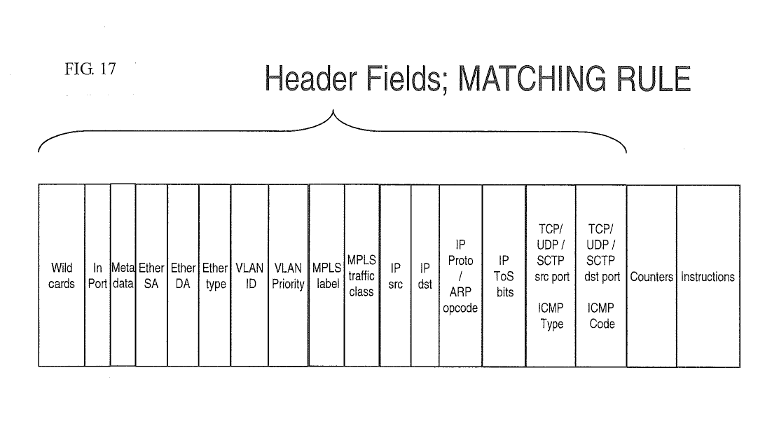

FIG. 18 is a diagram showing the background art.

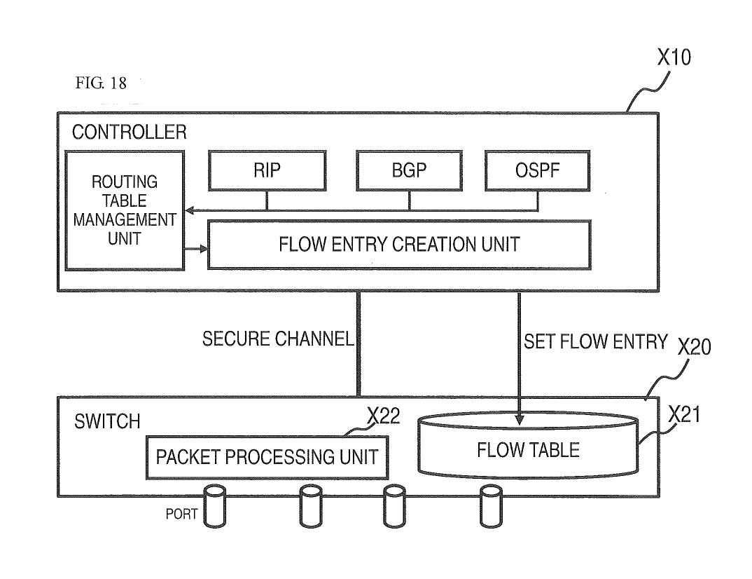

FIG. 19 is a diagram showing the outline configuration described in Non Patent Literature 3.

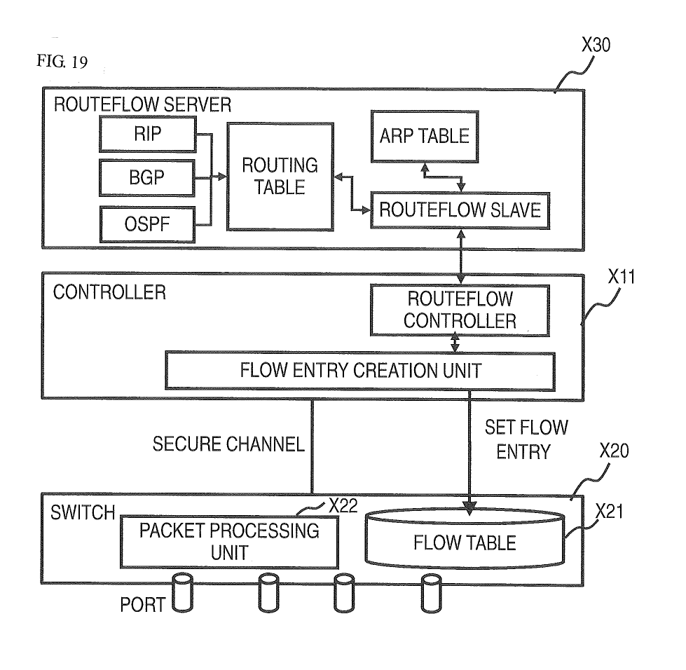

### DESCRIPTION OF EMBODIMENTS

First, the following describes the outline of one exemplary embodiment the present invention with reference to the drawings. Note that the drawing reference signs used in this outline are attached to the elements merely for the sake of convenience to help understand the present invention but are not intended to limit the present invention to the mode shown in the figures.

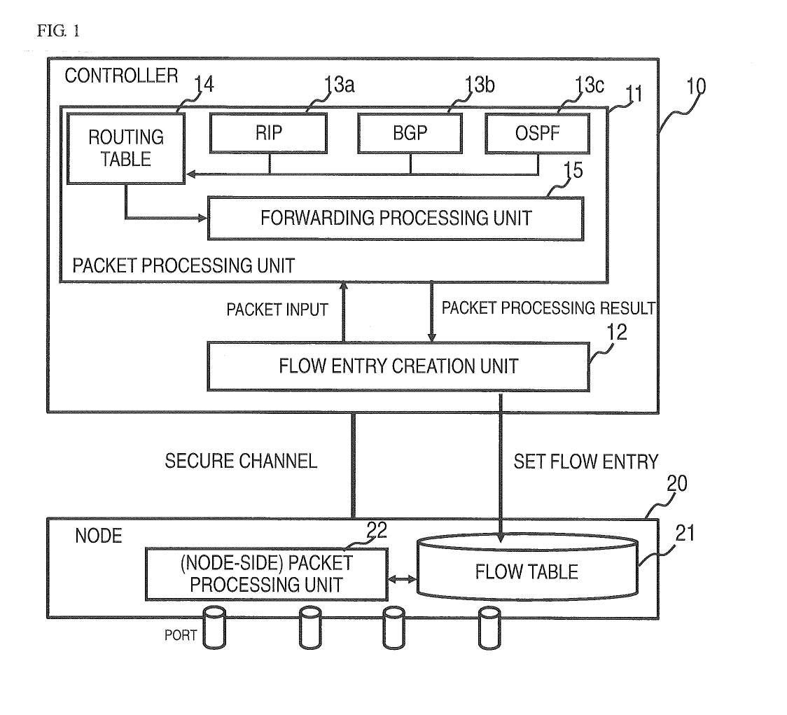

As shown in FIG. 1, one exemplary embodiment of the present invention is implemented by the configuration that includes a node 20, a controller 10 (corresponding to “control device” described above), and a packet processing unit 11. The node 20 includes a flow table 21 and a (node side) packet processing unit 22, and operates according to a processing rule that includes a matching rule, against which a received packet is matched, and a processing content to be applied to a packet that matches the matching rule. The controller 10 sets the processing rule (hereinafter called a flow entry) in the node 20 in response to a request received from the node 20. The packet processing unit 11 performs packet processing according to a pre-defined specification. More specifically, the controller 10 includes a flow entry creation unit 12 (corresponding to “processing rule creation unit” described above) that inputs a packet, received from the node 20 to request to create a flow entry, to the packet processing unit 11 and creates a flow entry. This flow entry, generated in response to the input, corresponds to the packet processing result of the packet processing unit 11. Note that the packet processing unit 11 performs packet processing equivalent to that of an IPv4 router.

The node 20 may be implemented by an OpenFlow switch described in Non Patent Literatures 1 and 2 or its equivalent product.

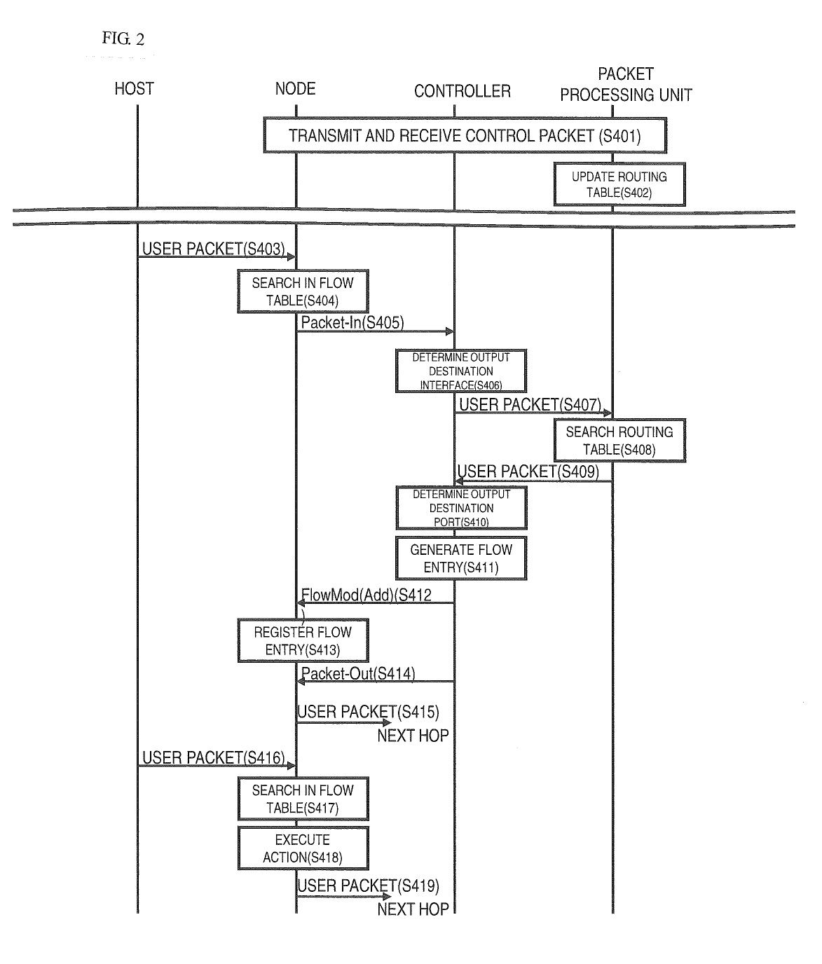

FIG. 2 is a sequence diagram showing the operation outline of one exemplary embodiment of the present invention. As shown in FIG. 2, the packet processing unit 11 updates the routing table either by transmitting and receiving a control packet, such as an RIP, OSPF, or BGP packet, to and from the node 20 via the controller 10 (S401 in FIG. 2) or based on the static setting by the administrator (S402 in FIG. 2).

After that, when a new user packet is received from the host (S403 in FIG. 2), the node 20 searches the flow table 21 for a flow entry having a matching rule that matches the received user packet (S404 in FIG. 2).

Because the packet received from the host is a new user packet in this example, the flow table 21 of the node 20 does not include a flow entry that matches the received packet. Therefore, the node 20 requests the controller 10 to set a flow entry that matches the received packet (Packet-In FIG. 2; S405).

In response to the packet-in message, the controller 10 determines the interface (output destination interface) via which the packet, received with the packet-in message, is to be sent to the packet processing unit 11 (S406 in FIG. 2) and transmits the packet, received with the packet-in message, to the packet processing unit 11 (S407 in FIG. 2).

The packet processing unit 11 searches the routing table, updated in steps S401 and S402 as described above, to determine the forwarding destination of the received packet (S408 in FIG. 2), and outputs the packet to the controller 10 (S409 in FIG. 2).

The controller 10 determines a port, from which the packet is to be output from the node 20, based on the interface from which the packet is output from the packet processing unit 11 (S410 in FIG. 2), and generates a flow entry that causes the packets, subsequent to the current packet, to be output from the port that has been determined (S411 in FIG. 2).

Next, the controller 10 sets the generated flow entry in the node 20 (FlowMod(Add) in FIG. 2; S412, S413). In addition, the controller 10 instructs the node 20 to transmit the packet, for which the flow entry setting request was received in step S405, from the determined port (Packet-Out in FIG. 2; S414). The node 20 transmits the packet to the next hop from the specified port according to the instruction (S415 in FIG. 2).

After that, when a following packet is received from the host (S416 in FIG. 2), the node 20 searches the flow table 21 for a flow entry that has a matching rule that matches the received packet (S417 in FIG. 2). In this case, because the flow entry for processing the following packet is already registered as described above, the instruction for forwarding the packet to the next hop is executed according to the flow entry (S418, S419 in FIG. 2).

Instead of observing the routing table provided internally in the packet processing unit 11 that performs the IPv4 router packet processing, the packet forwarding operation is observed in this exemplary embodiment and, based on the result, a flow entry is created as described above. This configuration allows the node 20 to perform the operation equivalent to that of a router at a cost much lower than that of the configuration described in the background art.

### First Exemplary Embodiment

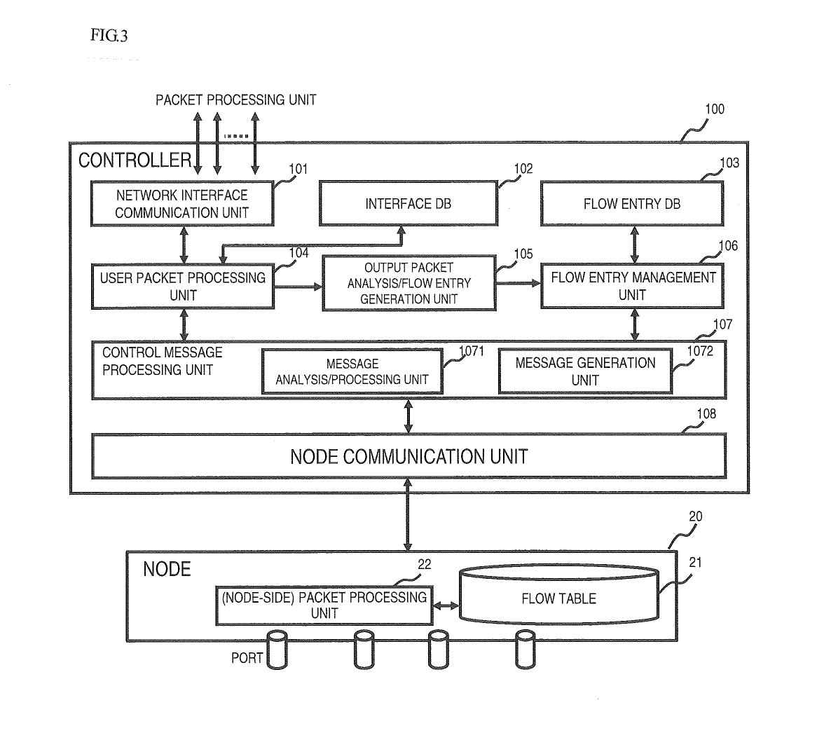

Next, to describe the present invention more specifically, a first exemplary embodiment of the present invention will be described more in detail below with reference to the drawings. FIG. 3 is a block diagram showing the configuration of the first exemplary embodiment of the present invention. FIG. 3 shows the detailed configuration of a controller 100 that controls a node 20 that has a flow table 21 and a (node side) packet processing unit 22. Unlike the packet processing unit connected to a network interface communication unit 101 of the controller 100, the (node side) packet processing unit 22 performs packet processing using an entry, stored in the flow table 21, as the processing rule.

The packet processing unit used in this exemplary embodiment is assumed to be equivalent to the packet processing unit 11 that performs packet processing of the IPv4 router shown in FIG. 1. That is, it is assumed that the daemon of the routing protocols in the packet processing unit 11, such as RIP, BGP, and OSPF, communicates with the node 20 to update the internal routing table. It is also assumed that the controller 100 only relays a control packet between the node 20 and the routing protocol daemon as necessary but is not concerned in changing the routine table.

The controller 100 includes the following units: network interface communication unit 101 connected to multiple network interfaces on the packet processing unit side for transmitting and receiving packets; interface database (interface DB) 102 corresponding to a storage unit that stores the correspondence between the ports on the node 20 and the network interfaces; flow entry database (flow entry DB) 103 that stores processing rules (flow entries) that are set in the node 20; user packet processing unit 104 that inputs a packet, received from a node via a node communication unit 108 and a control message processing unit 107, to the packet processing unit and outputs the result to an output packet analysis/flow entry generation unit 105; output packet analysis/flow entry generation unit 105 that generates a flow entry based on the content received from the user packet processing unit 104; flow entry management unit 106 that registers the generated flow entry in the flow entry DB 103 and sets the flow entry in the node 20; control message processing unit 107; and a node communication unit 108 that communicates with the node 20.

In the configuration shown in FIG. 3, the flow entry DB 103 may be omitted if there is no need to store the flow entries that are set in the node 20. The interface DB 102 may be provided separately on an external device that the controller 100 can access.

In addition, the control message processing unit 107 includes a message analysis/processing unit 1071 that analyses a control message, received from the node 20, and performs necessary processing and a message generation unit 1072 that generates a message to be sent to the node 20.

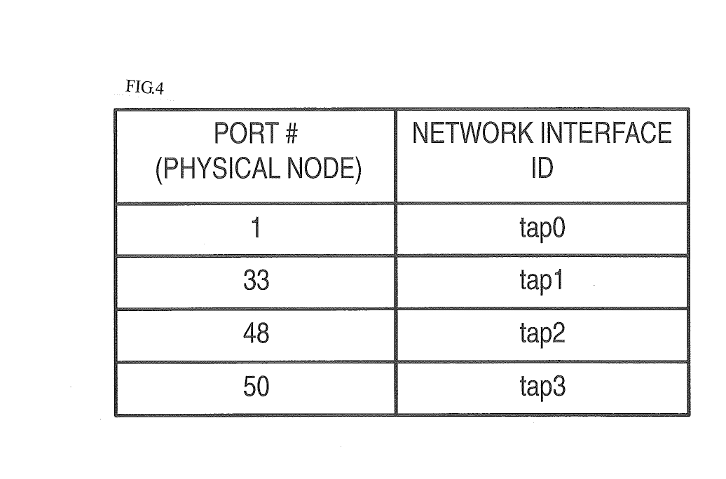

FIG. 4 is a diagram schematically showing the information stored in the interface DB 102. In the example shown in FIG. 4, ports #1, #33, #48, and #50 of a node (physical node) correspond respectively to network interfaces tap0-tap3. For example, a packet received from port #1 on the node (physical node) is input to the packet processing unit 11 from network interface tap0. After the packet is input, the behavior of the packet processing unit can be understood by observing the network interface that is used as the output destination of the packet from the packet processing unit 11. For example, if a packet received from port #1 is input to the packet processing unit 11 from the network interface tap0 and, after that, the packet is output from the network interface tap3 of the packet processing unit 11, it is estimated that the routing table stored in the packet processing unit 11 has an entry that causes the packet, received from port #1, to be output from port #50. Using this packet processing result, the output packet analysis/flow entry generation unit 105 generates a flow entry that causes a packet, received from port #1 on the node 20, to be output from port #50. The instruction (processing content) of a flow entry generated by the output packet analysis/flow entry generation unit 105 is not limited to the forwarding processing. For example, if the packet processing unit 11 performs various types of prioritized control processing, the output packet analysis/flow entry generation unit 105 generates a flow entry for implementing this control processing.

The controller 100 described above may be implemented by connecting the OpenFlow controller, described in Non Patent Literatures 1 and 2, to the packet processing unit and by adding at least the network interface communication unit 101, interface DB 102, user packet processing unit 104, and output packet analysis/flow entry generation unit 105 described above.

Each of the units (processing means) of the controller 100 may be implemented by a computer program that causes a computer, which constitutes the controller 100, to execute the processing described above using the hardware.

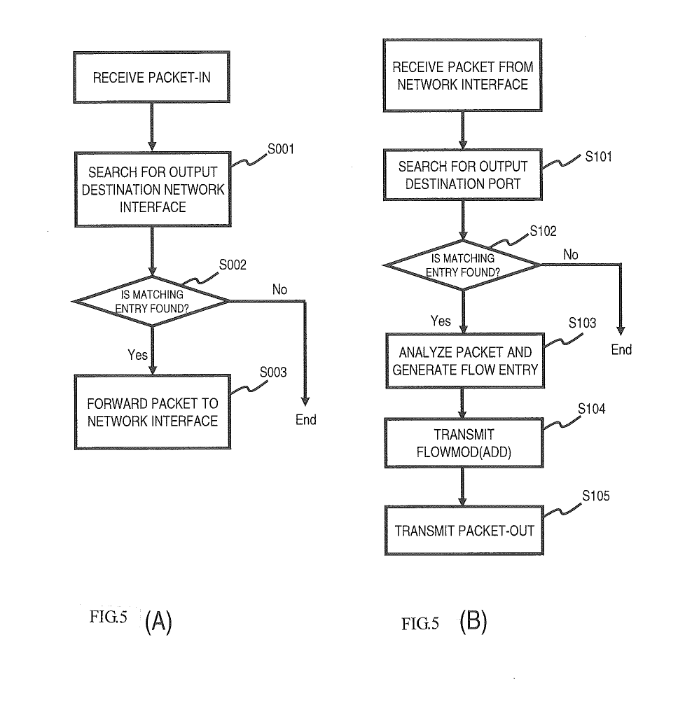

Next, the following describes the operation of the controller 100. FIG. 5 is a flowchart showing the operation of the controller 100. The flowchart A shown in the left half of FIG. 5 indicates that, when a flow entry creation request (Packet-In) is received from the node 20, the controller 100 references the interface DB 102 to search for the network interface corresponding to the reception port of the node 20 from which the packet, attached to the flow entry creation request (Packet-In), was received (step S001; Packet-In). If there is no matching entry in the interface DB 102 as the result of the search (No in step S002), the controller 100 terminates the processing. In this case, if the packet is received from a node that is not the node 20 and is not associated with the packet processing unit, it is also possible for the controller 100 to create a route for the node or to request another controller to create a route as described in the description of the background art.

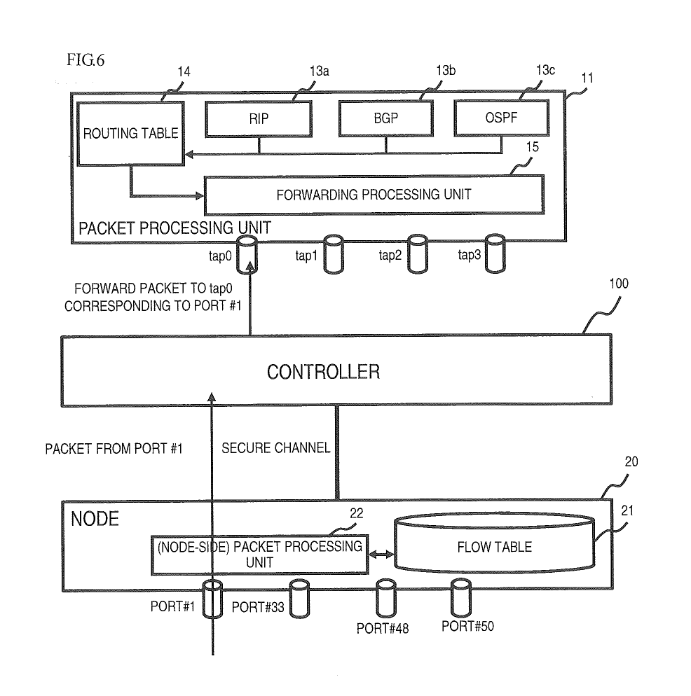

On the other hand, if a matching entry is found (Yes in step S002) as the result of the search, the controller 100 forwards the user packet, received from the node 20, to the network interface described in the entry (step S003). For example, if a flow entry creation request for a packet received via port #1 of the node 20 is received as shown in FIG. 6, the controller 100 references the interface DB 102 and forwards the packet to network interface tap0 associated with port #1 of the node 20.

After that, if a packet is received from a network interface of the packet processing unit, the controller 100 performs the operation according to flowchart B shown in the right half of FIG. 5. First, the controller 100 references the interface DB 102 to search for an output destination port associated with the network interface via which the packet was received (step S101). If there is no matching entry in the interface DB 102 as the result of the search (No in step S102), the controller 100 terminates the processing.

On the other hand, if a matching entry is found as the result of the search (Yes in step S102), the controller 100 generates a flow entry that causes the received packet to be forwarded from the output destination port described in the entry (step S103). In this case, if the packet processing unit has rewritten the packet header, it is possible for the controller 100 to add an instruction, corresponding to the rewritten content, to the flow entry.

Next, the controller 100 sets the generated flow entry in the node 20 (step S104; transmit FlowMod(Add)) to instruct the node 20 to forward the received packet (step S105; Packet-Out).

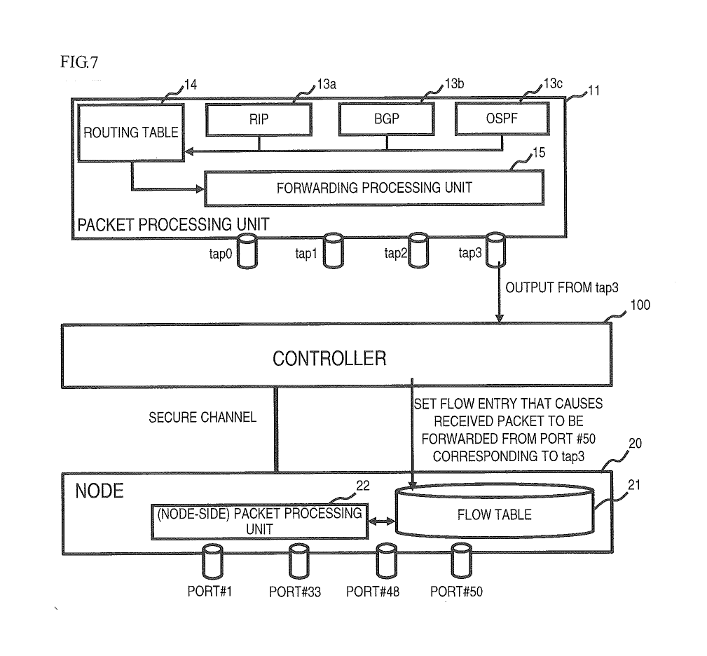

For example, a packet is forwarded to the network interface tap0 of the packet processing unit and, after that, the packet is received from network interface tap3 as shown in FIG. 7, the controller 100 references the interface DB 102 and identifies port #50 of the node 20 as the output destination port associated with the network interface tap3. Finally, the controller 100 generates and sets a flow entry defining an instruction that causes the received packet to be forwarded from port #50.

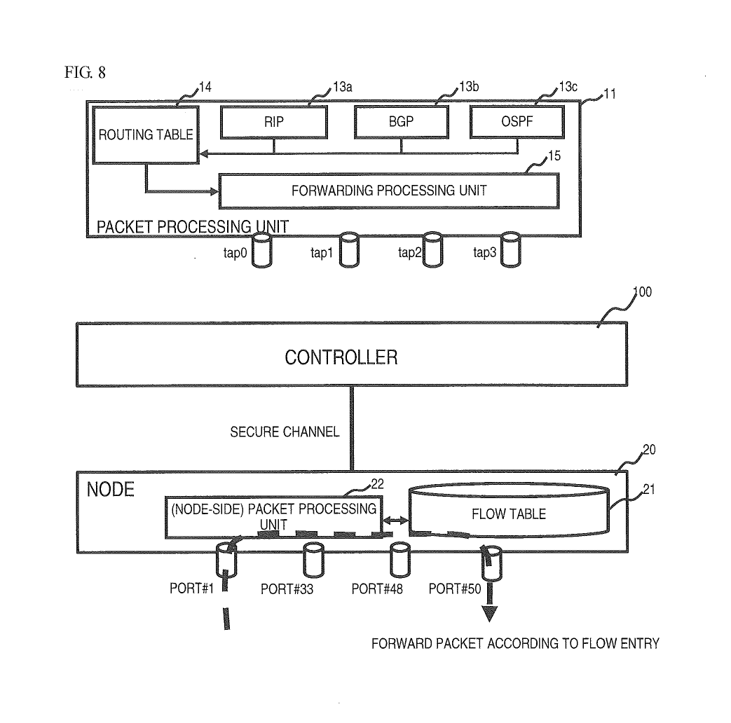

After that, the forwarding processing is performed as shown in FIG. 8 according to the flow entry that is set in the node 20 in the same way the forwarding processing is performed according to the routing table in the packet processing unit.

As described above, this exemplary embodiment allows the node 20 to behave equivalently to an IPv4 router without the controller having to manage the routing table or monitoring a change in the routing table. In addition, the configuration may be built simply by providing a packet processing unit that operates equivalently to a communication device conforming to the predetermined specification (such a packet processing unit can be configured easily using the existing routing protocol stack) and by adding the storage unit, which stores the correspondence between nodes and the interfaces of the packet processing unit, as well as the flow entry generation function based on the result. Therefore, this exemplary embodiment may be implemented at a low cost.

### Second Exemplary Embodiment

Next, the following describes a second exemplary embodiment in detail with reference to the drawings. The second exemplary embodiment is obtained by adding modifications to the first exemplary embodiment described above. In the first exemplary embodiment described above, the output is observed only when a packet is received from the node 20. On the other hand, the routing table is updated by the packet processing unit at a predetermined time and, therefore, changes in the routing table, stored in the packet processing unit, are not sometimes reflected on the flow entries stored in the node 20.

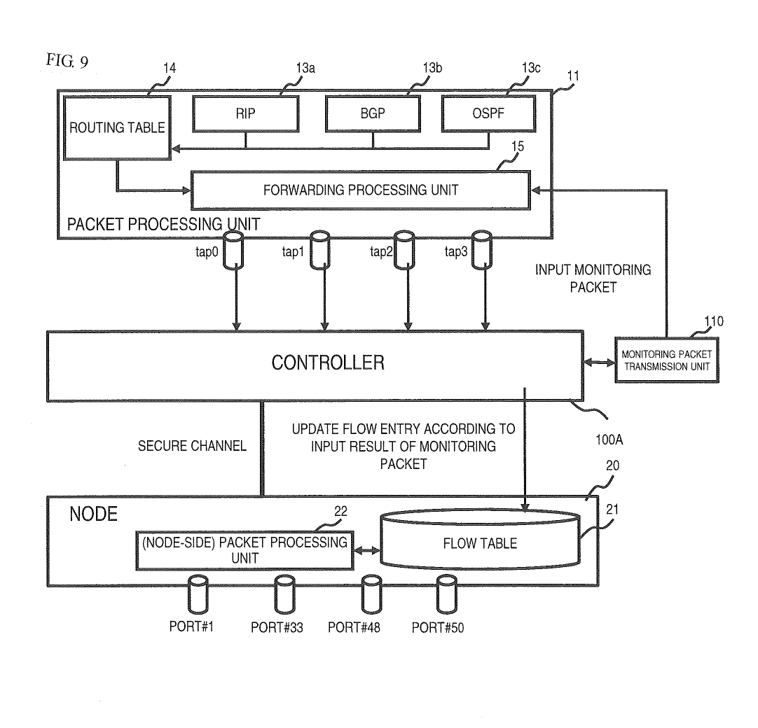

To address this problem, a monitoring packet transmission unit 110, which transmits a monitoring packet to a network interface of a packet processing unit 11 at a predetermined time, is added as shown in FIG. 9. Because the basic configuration is similar to that of the first exemplary embodiment, the following describes the second exemplary embodiment with focus on the difference from the first exemplary embodiment.

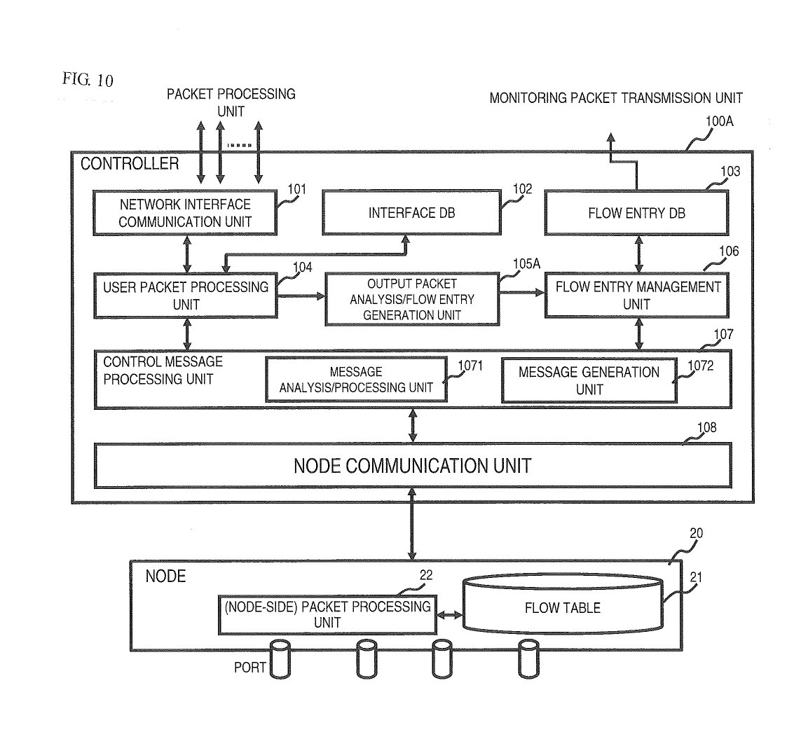

FIG. 10 is a block diagram showing the detailed configuration of the second exemplary embodiment of the present invention. The differences from the first exemplary embodiment, shown in FIG. 3, are the following two: (1) an entry in a flow entry DB 103 is referenced by the monitoring packet transmission unit and (2) the flow entry update function for use by the monitoring packet is added to an output packet analysis/flow entry generation unit 105A.

The monitoring packet transmission unit 110 reads a flow entry from the flow entry DB 103, generates a monitoring packet that includes the header, which matches the matching rule of the flow entry, and the information indicating that the packet is a monitoring packet. After that, the monitoring packet transmission unit 110 transmits the generated monitoring packet to the packet processing unit. A dummy packet such as an ICMP echo request packet, which is used for the ping test, may be used as the monitoring packet.

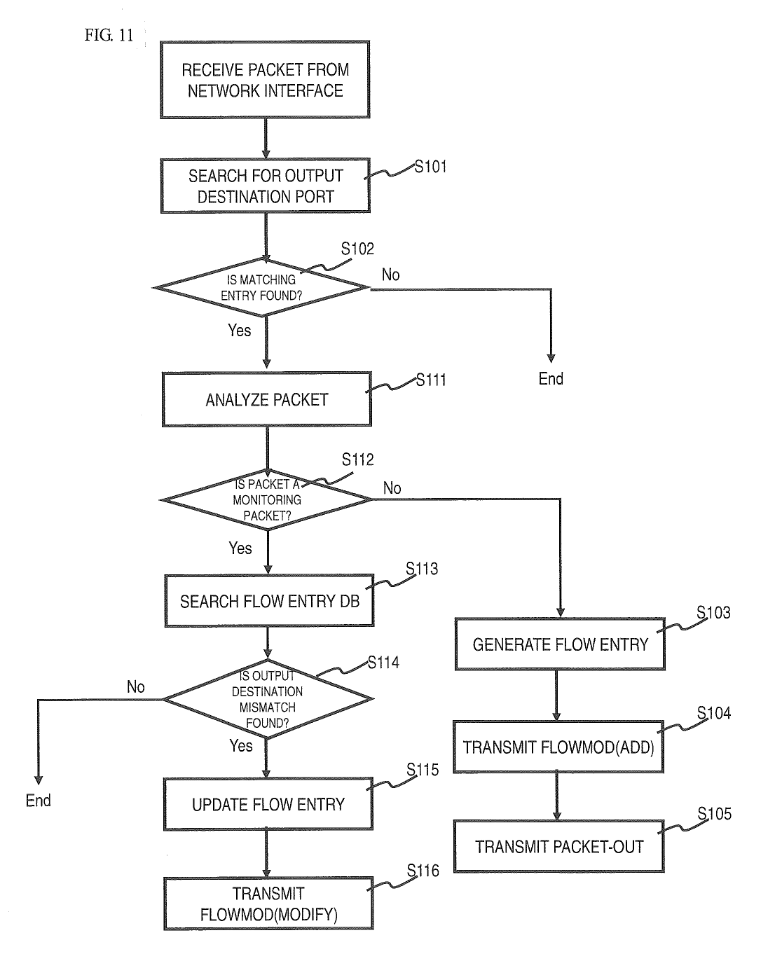

FIG. 11 is a flowchart showing the operation of the controller in the second exemplary embodiment of the present invention. Steps S111 to S116 are added to flowchart B in the right half of FIG. 5 that shows the operation of the controller in the first exemplary embodiment.

Referring to FIG. 11, a controller 100A that receives a packet from a network interface references the interface DB 102 to search for an output destination port corresponding to the network interface that received the packet (step S101). If there is no matching entry in the interface DB 102 as the result of the search, the controller 100A terminates the processing (No in step S102).

On the other hand, if there is a matching entry as the result of the search (Yes in step S102), the controller 100A analyzes the packet (step S111). If the received packet is not a monitoring packet as the result of the packet analysis, for example, if the received packet is a user packet (No in step S112), the controller 100A generates and sets a flow entry based on the identified output destination port, and instructs the node 20 to forward the packet as in the first exemplary embodiment (see steps S103-S105 in FIG. 5).

On the other hand, if it is determined as the result of the packet analysis that the received packet is a monitoring packet (Yes in step S112), the controller 100A searches the flow entry DB 103 for a flow entry that has a matching rule that matches the received packet (monitoring packet) (step S113).

Next, the controller 100A references the interface DB 102 to identify the port corresponding to the network interface from which the received packet (monitoring packet) was output. In addition, the controller 100A checks if the identified port matches the output destination port specified in the instruction field of the flow entry searched for in step S113 (step S114). If the identified port matches the output destination port specified in the instruction field of the flow entry that has been searched for (No in step S114), the controller terminates the processing.

On the other hand, if the identified port does not match the output destination port specified in the instruction field of the flow entry that has been searched for (Yes in step S114), the controller 100A rewrites the content of the instruction field of the flow entry that has been searched for to the content indicating the forwarding to the identified port (step S115) and sets the flow entry in the node (step S116).

As described above, this exemplary embodiment allows a change in the routing table in the packet processing unit to be reflected on a flow entry in the node 20 as soon as possible.

Although the monitoring packet transmission unit 110 reads a flow entry from the flow entry DB 103 and generates a monitoring packet in the exemplary embodiment described above, it is also possible to use an arbitrary monitoring packet generation rule to automatically generate a monitoring packet. The monitoring packet is any packet that is generated in association with a flow entry, for which a check is required to see if update is required, and is identifiable as a monitoring packet.

### Third Exemplary Embodiment

Next, the following describes a third exemplary embodiment in detail with reference to the drawings. The third exemplary embodiment is obtained by adding modifications to the first exemplary embodiment described above. Although there is a one-to-one correspondence between the node 20 and the packet processing unit 11 in the first and second exemplary embodiments, it is also possible to allow multiple nodes to behave as if they were one communication device.

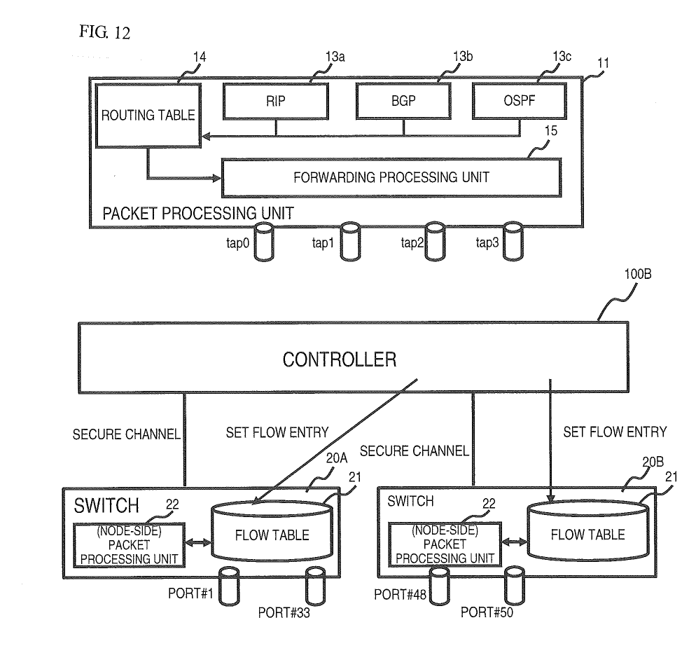

To satisfy this need, a controller 100B controls multiple nodes, node 20A and node 20B, as shown in FIG. 12 in the third exemplary embodiment of the present invention. Because the basic configuration is similar to that of the first exemplary embodiment, the following describes the third exemplary embodiment with focus on the difference from the first exemplary embodiment.

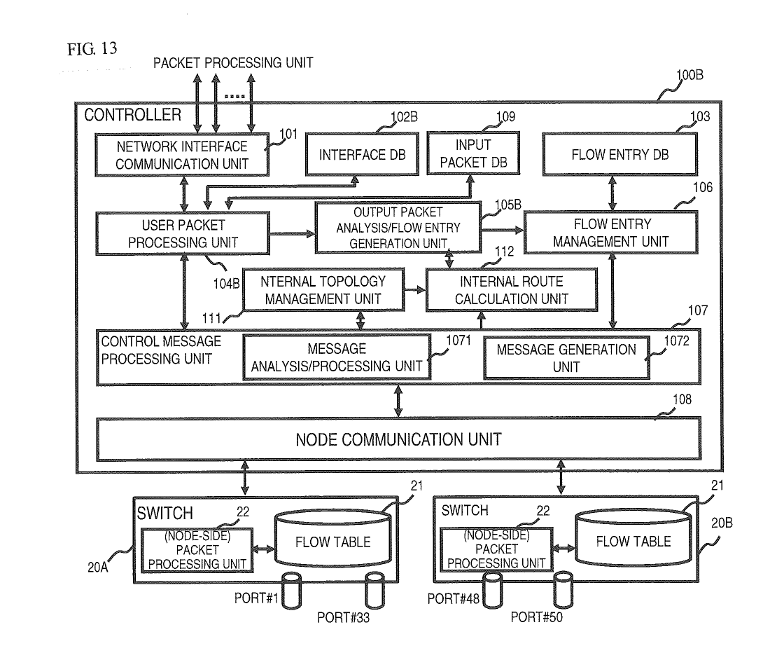

FIG. 13 is a block diagram showing the detailed configuration of the third exemplary embodiment of the present invention. The third exemplary embodiment differs from the first exemplary embodiment shown in FIG. 3 in that an input packet database (input packet DB) 109, an internal topology management unit 111, and an internal route calculation unit 112 are added to the controller 100B and in that modifications are added to an interface DB 102B, a user packet processing unit 104B, and an output packet analysis/flow entry generation unit 105B.

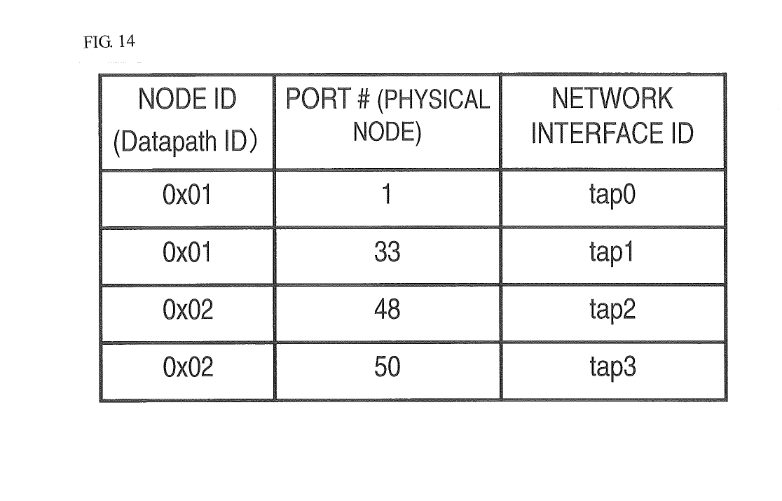

FIG. 14 is a diagram schematically showing the information stored in the interface DB 102B. This information differs from the information in the interface DB 102 in the first exemplary embodiment shown in FIG. 4 in that a node ID (Datapath ID) is added to each entry. For example, a packet received from port #1 of the node 20A is input to the packet processing unit 11 from network interface tap0. And, for example, if a packet received from port #1 is input to the packet processing unit 11 via network interface tap0 and, after that, the packet is output from network interface tap 3 of the packet processing unit 11, it is estimated that the routing table stored in the packet processing unit 11 has an entry that causes the packet, received from port #1, to be output from port #50. The output packet analysis/flow entry generation unit 105B uses this packet processing result to generate a flow entry that causes a packet received from port #1 of the node 20A to be output from port #50 of the node 20B. At this point, the packet must be forwarded from the node 20A to the node 20B and, therefore, the input packet DB 109, internal topology management unit 111, and internal route calculation unit 112, which will be described later, are used.

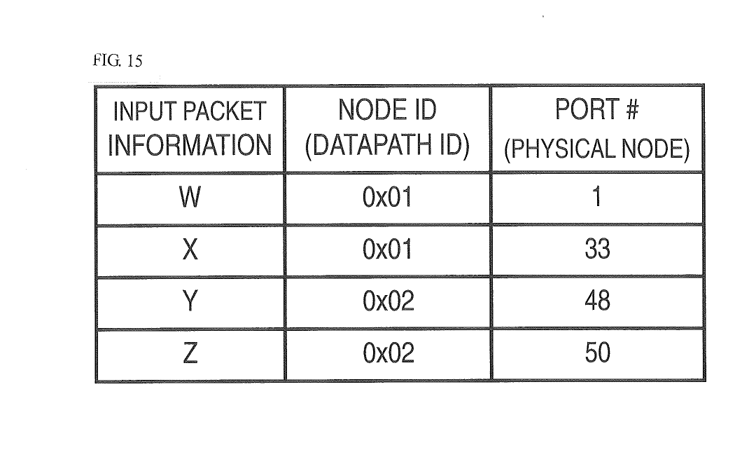

FIG. 15 is a diagram schematically showing the information stored in the input packet DB 109. In the example shown in FIG. 15, an entry in the input packet DB 109 includes the input packet information such as the header information on an input packet, the node ID (Datapath ID), and the port number (#) of a (physical) node. For example, when a user packet is received from the node side, the user packet processing unit 104B registers the input packet information W, node ID, and port # in the input packet DB 109. If a packet received from port #1 is input to the packet processing unit 11 from network interface tap0 and, after that, the packet that has W as the input packet information is output from network interface tap3 of the packet processing unit 11, it is possible to reverse search the registered information to determine that the packet is a packet received from port #1 of the node 20A whose node ID is 0x01.

The internal topology management unit 111 manages the connection relation between the node 20A and the node 20B. The internal route calculation unit 112 calculates the route between the node, from which a user packet is received, and the node, to which the user packet is to be output, in response to a request from the output packet analysis/flow entry generation unit 105B. For example, if a request to calculate the route between the node 20A and the node 20B is received from the output packet analysis/flow entry generation unit 105B, the internal route calculation unit 112 references the information, stored in the internal topology management unit 111, to calculate the route and returns the calculation result to the output packet analysis/flow entry generation unit 105B.

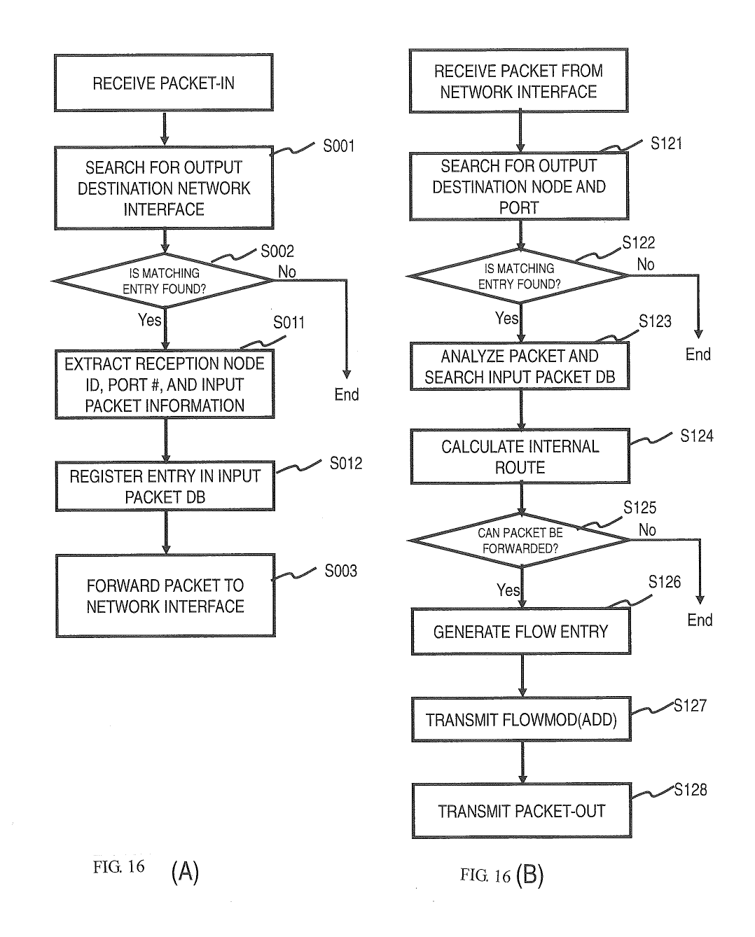

Next, the following describes the operation of the controller 100B described above. FIG. 16 is a flowchart showing the operation of the controller 100B. Referring to flowchart A in the left half of FIG. 16, the controller 100B, which receives a flow entry creation request (Packet-In) from the node 20A (or node 20B), references the interface DB 102B to search for the network interface corresponding to the reception port of the node 20A (or node 20B) from which the packet, attached to the flow entry creation request (Packet-In), was received (step S001; Packet-In). If there is no matching entry in the interface DB 102B as the result of the search, the controller 100B terminates the processing (No in step S002).

On the other hand, if a matching entry is found as the result of the search (Yes in step S002), the controller 100B extracts the input packet information, node IF, and port number (#), which are described above, from the packet attached to the flow entry creation request (Packet-In) (step S011) and registers them in the input packet DB 109 (step S012).

After that, the controller 100B forwards the user packet, received from the node 20, to the network interface described in the entry searched for in step S001 (step S003). For example, when a flow entry creation request for a packet received from port #1 of the node 20A is received, the controller 100B references the interface DB 102B and forwards the packet to network interface tap0 associated with port #1 of the node 20.

After that, when a packet is received from a network interface of the packet processing unit, the controller 100B performs the operation according to flowchart B shown in the right half of FIG. 16. First, the controller 100B references the interface DB 102B to search for the node ID and the output destination port corresponding to the network interface from which the packet is received (step S121). If there is no matching entry in the interface DB 102B as the result of the search, the controller 100B terminates the processing (No in step S122).

On the other hand, if a matching entry is found as the result of the search (Yes in step S122), the controller 100B extracts the input packet information from the received packet and searches the input packet DB 109 for an entry that has the matching input packet information (step S123).

At this point, the reception node and the reception port of the packet received from the network interface and the output node and the port to which the packet is to be output are known. Based on this information, the controller 100B causes the internal route calculation unit 112 to calculate the route between the reception node and the output node (step S124). If it is determined that the packet cannot be forwarded during the calculation, the controller 100B terminates the processing (No in step S125).

On the other hand, if it is determined that the packet can be forwarded, the controller 100B generates a flow entry that causes the packet to be forwarded from the input node to the output node and then forwarded from the specified node of the output node (step S126).

Next, the controller 100B sets the generated flow entries in the nodes 20A and 20B (step S127; transmit FlowMod(Add)) to instruct the nodes to forward the received packet (step S128; Packet-Out).

Consider the case in which the information on a packet, received from port #1 of the node 20A in FIG. 12, is registered in the input packet DB 109 and, at the same time, the packet is input to network interface tap0 according to the interface DB 102B in FIG. 14. For example, if the packet is input to network interface tap0 and, after that, the packet is received from network interface tap3, the controller 100B references the interface DB 102 to identify port #50 of the node 20B as the output destination port associated with network interface tap3. In addition, the controller 100B references the input packet DB 109 to identify that the packet was received from port #1 of the node 20A. Based on this information, the controller 100B sets a flow entry, which causes the packets subsequent to that packet to be transferred to the node 20B, in the node 20A and, at the same time, sets a flow entry, which causes the packets subsequent to that packet to be forwarded from port #50, in the node 20B.

After that, the subsequent packets, which are received from port #1 of the node 20A in FIG. 12, are forwarded to the node 20B, not via the controller 100B, and then output from port #50 of the node 20B.

As described above, this exemplary embodiment allows multiple nodes to behave as if they were one communication device, at a low cost. In this case, too, the configuration may be built at a low cost simply by providing a packet processing unit that operates equivalently to a communication device conforming to the predetermined specification (such a packet processing unit can be configured easily using the existing routing protocol stack) and by providing on the controller side the function equivalent to the interface DB 102, input packet DB 109, user packet processing unit 104B, output packet analysis/flow entry generation unit 105B, internal topology management unit 111, and internal route calculation unit 112.

While the preferred exemplary embodiments of the present invention have been described, it is to be understood that the present invention is not limited to the exemplary embodiments described above and that further modifications, replacements, and adjustments may be added within the scope not departing from the basic technological concept of the present invention. For example, the number of nodes, ports, and network interfaces in the exemplary embodiments above are used only to help understand the present invention. The present invention is not limited by those numbers.

Although the packet processing unit performs the operation equivalent to that of an IPv4 router in the exemplary embodiments described above, the nodes 20, 20A, and 20B may be used to perform the operation similar to that of an IPv6 router as well as various types of gateway or packet processing unit because there is no need to monitor the information, such as the routing table, stored in the packet processing unit.

Although the packet processing unit and the monitoring packet transmission unit are connected externally of the controller 100, 100A, or 100B in the exemplary embodiments described above, the configuration such as that shown in FIG. 1 is also possible in which the packet processing unit or the monitoring packet transmission unit is provided in the controller 10.

Although the controller 100, 100A, or 100B performs a sequence of operations in the exemplary embodiments described above, the function equivalent to that of the controller 100, 100A, or 100B may also be added to the node 20, 20A, or 20B to allow the node 20, 20A, or 20B to input a packet directly to the emulator unit and, based on the result, to generate a flow entry.

Finally, the preferred modes of the present invention are summarized below.

### (First Mode)

(See the communication system in the first aspect above)

### (Second Mode)

The communication system in the first mode, wherein

the control device

comprises a storage unit that stores a correspondence between interfaces of the packet processing unit and interfaces of the node and

creates a processing rule that causes packets, subsequent to the packet received from the node to request to create a processing rule, to be output from an interface of the node, the interface of the node corresponding to an interface of the packet processing unit from which the packet is output.

### (Third Mode)

The communication system in the first or second mode, wherein

the packet processing unit stores a routing table and performs packet processing, including determination of a forwarding destination, by referring to the routing table.

### (Fourth Mode)

The communication system in one of the first to third modes, further comprising:

a monitoring packet transmission unit that inputs a monitoring packet, corresponding to a processing rule stored in the node, to the packet processing unit at a predetermined interval; and

a second storage unit that stores the processing rule that is set in the node wherein

the control device detects a change in the packet processing result of the packet processing unit obtained as a result of the input of the monitoring packet and updates the processing rule stored in the node.

### (Fifth Mode)

The communication system in one of the first to fourth modes, wherein

the control device sets a processing rule in each of a plurality of nodes to cause the plurality of nodes to perform packet processing equivalent to the packet processing of the packet processing unit.

### (Sixth Mode)

The communication system in the fifth mode wherein the control device further comprises:

a third storage unit that stores information on packets received from the node;

an internal topology management unit that stores a connection relation between the plurality of nodes; and

an internal route calculation unit that calculates a route between any two nodes of the plurality of nodes and wherein

the control device inputs a packet, received from one of the plurality of nodes to request to create a processing rule, to the packet processing unit, calculates a route from the one of the nodes to an output node based on the packet processing result of the packet processing unit obtained as a result of the input, and creates a processing rule that is set in each of the nodes on the route.

### (Seventh Mode)

(See the control device in the second aspect above)

### (Eighth Mode)

The control device in the seventh mode, further comprising:

a storage unit that stores a correspondence between interfaces of the packet processing unit and interfaces of the node wherein

the control device creates a processing rule that causes packets, subsequent to the packet received from the node to request to create a processing rule, to be output from an interface of the node, the interface of the node corresponding to an interface of the packet processing unit from which the packet is output.

### (Ninth Mode)

The control device in the seventh or eighth mode, further comprising:

as the packet processing unit, a packet processing unit that stores a routing table and performs packet processing, including determination of a forwarding destination, by referring to the routing table.

### (Tenth Mode)

The control device in one of the seventh to ninth modes, further comprising:

a second storage unit that stores the processing rule that is set in the node wherein

the control device detects a change in the packet processing result of the packet processing unit for a monitoring packet that is input to the packet processing unit at a predetermined interval and updates the processing rule stored in the node.

### (Eleventh Mode)

The control device in one of the seventh to ninth modes, further comprising:

a second storage unit that stores the processing rule that is set in the node; and

a monitoring packet transmission unit that inputs a monitoring packet, corresponding to the processing rule stored in the node, to the packet processing unit at a predetermined interval wherein

the control device detects a change in the packet processing result of the packet processing unit obtained as a result of the input of the monitoring packet and updates the processing rule stored in the node.

### (Twelfth Mode)

The control device in one of the seventh to eleventh modes, wherein

the control device sets a processing rule in each of a plurality of nodes to cause the plurality of nodes to perform packet processing equivalent to the packet processing of the packet processing unit.

### (Thirteenth Mode)

The control device the twelfth mode, further comprising:

a third storage unit that stores information on packets received from the node;

an internal topology management unit that stores a connection relation between the plurality of nodes; and

an internal route calculation unit that calculates a route between any two nodes of the plurality of nodes, wherein

the control device inputs a packet, received from one of the plurality of nodes to request to create a processing rule, to the packet processing unit, calculates a route from the one of the nodes to an output node based on the packet processing result of the packet processing unit obtained as a result of the input, and creates a processing rule that is set in each of the nodes on the route.

### (Fourteenth Mode)

(See the node in the third aspect above)

### (Fifteenth Mode)

(See the node control method in the fourth aspect above)

### (Sixteenth Mode)

(See the program in the fifth aspect above)

Specific modes may be derived from the fourteenth to sixteenth modes in the same manner as in the first mode and the seventh mode.

The disclosure of Patent Literature and Non Patent Literatures given above is hereby incorporated by reference into this specification. The exemplary embodiments and examples may be changed and adjusted in the scope of the entire disclosure (including claims) of the present invention and based on the basic technological concept. In the scope of the claims of the present invention, various disclosed elements (including elements of the claims, elements of the exemplary embodiments and examples, and elements of the drawings) may be combined and selected in a variety of ways.

### REFERENCE SIGNS LIST

10,100,100A,100B Controller
11 Packet processing unit
12 Flow entry creation unit
13a-13c Routing protocol stack
14 Routing table
15 Forwarding processing unit
20,20A,20B Node
21 Flow table
22 (Node side) packet processing unit
101 Network interface communication unit
102,102B Interface DB
103 Flow entry DB
104,104B User packet processing unit
105,105A,105B Output packet analysis/flow entry generation unit
106 Flow entry management unit
107 Control message processing unit
108 Node communication unit
109 Input packet DB
110 Monitoring packet transmission unit
111 Internal topology management unit
112 Internal route calculation unit
1071 Message analysis/processing unit
1072 Message generation unit

1. A communication system, comprising:
a node that operates according to a processing rule, the processing rule including a matching rule, against which a received packet is matched, and processing content applied to a packet that matches the matching rule; and
a control device that sets the processing rule in said node in response to a request from said node, wherein
said control device is connected to a packet processing unit that performs packet processing according to a predetermined specification and
said control device comprises a processing rule creation unit that inputs a packet, received from said node to request to create a processing rule, to said packet processing unit and creates a processing rule corresponding to a packet processing result of said packet processing unit obtained as a result of the input.

2. The communication system as defined by claim 1, wherein
said control device
comprises a storage unit that stores a correspondence between interfaces of said packet processing unit and interfaces of said node and
creates a processing rule that causes packets, subsequent to the packet received from said node to request to create a processing rule, to be output from an interface of said node, the interface of said node corresponding to an interface of said packet processing unit from which the packet is output.

3. The communication system as defined by claim 1, wherein
said packet processing unit stores a routing table and performs packet processing, including determination of a forwarding destination, by referring to the routing table.

4. The communication system as defined claim 1, further comprising:
a monitoring packet transmission unit that inputs a monitoring packet, corresponding to a processing rule stored in said node, to said packet processing unit at a predetermined interval; and
a second storage unit that stores the processing rule that is set in said node wherein
said control device detects a change in the packet processing result of said packet processing unit obtained as a result of the input of the monitoring packet and updates the processing rule stored in said node.

5. The communication system as defined by claim 1, wherein
said control device sets a processing rule in each of a plurality of nodes to cause said plurality of nodes to perform packet processing equivalent to the packet processing of said packet processing unit.

6. The communication system as defined by claim 5 wherein said control device further comprises:
a third storage unit that stores information on packets received from said node;
an internal topology management unit that stores a connection relation between said plurality of nodes; and
an internal route calculation unit that calculates a route between any two nodes of said plurality of nodes and wherein
said control device inputs a packet, received from one of said plurality of nodes to request to create a processing rule, to said packet processing unit, calculates a route from said one of the nodes to an output node based on the packet processing result of said packet processing unit obtained as a result of the input, and creates a processing rule that is set in each of the nodes on the route.

7. A control device, which is connected to a node that operates according to a processing rule and to a packet processing unit that performs packet processing according to a predetermined specification, the processing rule including a matching rule, against which a received packet is matched, and processing content applied to a packet that matches the matching rule, said control device comprising:
a processing rule creation unit that inputs a packet, received from said node to request to create a processing rule, to said packet processing unit in response to a request from said node and creates a processing rule corresponding to a packet processing result of said packet processing unit obtained as a result of the input; and
a processing rule setting unit that sets the created processing rule in said node.

8. The control device as defined by claim 7, further comprising:
a storage unit that stores a correspondence between interfaces of said packet processing unit and interfaces of said node wherein
said control device creates a processing rule that causes packets, subsequent to the packet received from said node to request to create a processing rule, to be output from an interface of said node, the interface of said node corresponding to an interface of said packet processing unit from which the packet is output.

9. The control device as defined by claim 7, further comprising:
as said packet processing unit, a packet processing unit that stores a routing table and performs packet processing, including determination of a forwarding destination, by referring to the routing table.

10. The control device as defined by claim 7, further comprising:
a second storage unit that stores the processing rule that is set in said node wherein
said control device detects a change in the packet processing result of said packet processing unit for a monitoring packet that is input to said packet processing unit at a predetermined interval and updates the processing rule stored in said node.

11. The control device as defined by claim 7, further comprising:
a second storage unit that stores the processing rule that is set in said node; and
a monitoring packet transmission unit that inputs a monitoring packet, corresponding to the processing rule stored in said node, to said packet processing unit at a predetermined interval wherein
said control device detects a change in the packet processing result of said packet processing unit obtained as a result of the input of the monitoring packet and updates the processing rule stored in said node.

12. The control device as defined by claim 7, wherein
said control device sets a processing rule in each of a plurality of nodes to cause said plurality of nodes to perform packet processing equivalent to the packet processing of said packet processing unit.

13. The control device as defined by claim 12, further comprising:
a third storage unit that stores information on packets received from said node;
an internal topology management unit that stores a connection relation between said plurality of nodes; and
an internal route calculation unit that calculates a route between any two nodes of said plurality of nodes, wherein
said control device inputs a packet, received from one of said plurality of nodes to request to create a processing rule, to said packet processing unit, calculates a route from said one of the nodes to an output node based on the packet processing result of said packet processing unit obtained as a result of the input, and creates a processing rule that is set in each of the nodes on the route.

14. (canceled)

15. A node control method, comprising:
using a control device connected to a node and to a packet processing unit, said node operating according to a processing rule that includes a matching rule, against which a received packet is matched, and processing content applied to a packet that matches the matching rule, said packet processing unit performing packet processing according to a predetermined specification, said control device performing processing comprising the steps of:
inputting a packet, received from said node to request to create a processing rule, to said packet processing unit in response to a request from said node;
creating a processing rule corresponding to a packet processing result of said packet processing unit obtained as a result of the input; and
setting the created processing rule in said node.

16. (canceled)
